(19) United States
(12) Patent Application Publication
(10) Pub. No.: US 2018/0357652 A1
(43) Pub. Date: Dec. 13, 2018

(54) APPARATUS AND METHOD FOR ANALYZING ENCRYPTED PURCHASING DATA

(71) Applicant: AT&T INTELLECTUAL PROPERTY I, L.P., Atlanta, GA (US)

(72) Inventors: SHELDON KENT MEREDITH, Roswell, GA (US); WILLIAM COTTRILL, Canton, GA (US); BIREN PAREKH, Cumming, GA (US)

(21) Appl. No.: 15/618,382

(22) Filed: Jun. 9, 2017

(51) Int. Cl. G06Q 30/02; G06Q 30/06; G06N 99/00; G06N 5/04

(52) U.S. Cl. CPC G06Q 30/0201; G06Q 30/0635; H04L 63/0428; G06N 5/04; G06Q 2220/00; G06N 99/005

(57) ABSTRACT

Aspects of the subject disclosure may include, for example, determining reference amounts of reference data traffic associated with different web pages of a website purchasing process, monitoring encrypted traffic associated with the website resulting in monitored data traffic segments, comparing monitored amounts of the monitored data traffic segments with the reference amounts of the reference data traffic, determining probabilities based on the comparing, and determining a probability that a purchase was made according to the probabilities. Other embodiments are disclosed.

### FIELD OF THE DISCLOSURE

The subject disclosure relates to an apparatus and method for analyzing encrypted purchasing data.

### BACKGROUND

Understanding sales trends for online retailers can provide many benefits, including competitive analytics, evaluations, and targeted advertising. Web visitation data is analyzed in an effort to understand sales trends of various on-line retailers. For instance, if we can see that people are visiting a particular retailer website ten percent more this quarter than last quarter, it might indicate an increase in on-line sales for the retailer.

However, web visitation data is indicative of a visit to a website and may not result in a purchase. Obtaining accurate indicators of sales volumes as opposed to just counting domain hits, is a difficult process where a large amount of web traffic is now encrypted, especially those pages associated with on-line purchasing check-out.

### BRIEF DESCRIPTION OF THE DRAWINGS

Reference will now be made to the accompanying drawings, which are not necessarily drawn to scale, and wherein:

FIG. 1 depicts an illustrative embodiment of a system that can determine a completed purchase probability based on encrypted traffic;

FIGS. 2-3 depicts an illustrative embodiment of a method used in portions of the system described in FIG. 1;

FIG. 4 depicts an illustrative embodiment of a communication device; and

FIG. 5 is a diagrammatic representation of a machine in the form of a computer system within which a set of instructions, when executed, may cause the machine to perform any one or more of the methods described herein.

### DETAILED DESCRIPTION

The subject disclosure describes, among other things, illustrative embodiments for determining a probability or otherwise estimating whether purchases have been made at particular websites based on an analysis of encrypted traffic. In one or more embodiments, a device and method provides for delivery of raw data session records to a processing sub-system where one or more of domain names, timestamps, transacted data volumes, presence or absence of ad-bot traffic and other information can be used in concert with a specialized web crawler to effect a machine learning system that can identify or otherwise determine a probability as to when a user is making a purchase on a web site, even if it is an https:, encrypted web site.

In one or more embodiments, reference (or baseline) traffic patterns can be determined for a purchase at a website and then encrypted traffic associated with that website can be compared with the reference traffic patterns for that website to determine a probability that a purchase was made without decrypting the encrypted traffic. The traffic patterns can be based on amounts of encrypted data being uploaded and/or downloaded for particular events within a purchase process, such as a shopping cart, check-out, payment, confirmation, and so forth. The traffic patterns can be based on data volumes of encrypted traffic for downloading of particular web pages and/or uploading of information. In one embodiment, differentials can be determined between amounts of encrypted data traffic and reference (or baseline) data amounts to determine probabilities of a purchase. The probabilities can be synthesized to determine an overall probability that a purchase was made at the website by the end user device. This information can be aggregated with other purchase probability data for other end user devices to monitor sales trending at the website Other embodiments are described in the subject disclosure.

One or more aspects of the subject disclosure are a method that includes accessing, by a processing system including a processor, a website. The method includes initiating, by the processing system, a purchasing process via the website. The method includes determining, by the processing system, a first reference amount of first reference data traffic associated with a first web page representing a shopping cart of the purchasing process. The method includes determining, by the processing system, a second reference amount of second reference data traffic associated with payment information for the purchasing process. The method includes completing, by the processing system, the purchasing process. The method includes monitoring, by the processing system, encrypted traffic associated with the website. The method includes comparing, by the processing system, a first monitored amount of first monitored data traffic of the encrypted traffic with the first reference amount of the first reference data traffic to determine a first differential traffic amount. The method includes determining, by the processing system, a first probability based on the first differential traffic amount. The method includes comparing, by the processing system, a second monitored amount of second monitored data traffic of the encrypted traffic with the second reference amount of the second reference data traffic to determine a second differential traffic amount. The method includes determining, by the processing system, a second probability based on the second differential traffic amount. The method includes determining, by the processing system, a probability that a purchase was made according to the first and second probabilities.

One or more aspects of the subject disclosure include a device having a processing system including a processor; and having a memory that stores executable instructions that, when executed by the processing system, facilitate performance of operations. The device can initiate a purchasing process via a website. The device can determine reference amounts of reference data traffic associated with different web pages of the purchasing process. The device can monitor encrypted traffic associated with the website resulting in monitored data traffic segments. The device can compare monitored amounts of the monitored data traffic segments with the reference amounts of the reference data traffic to determine differential traffic amounts. The device can determine probabilities based on the differential traffic amounts. The device can determine a probability that a purchase was made according to the probabilities.

One or more aspects of the subject disclosure can include a machine-readable storage medium, including executable instructions that, when executed by a processing system including a processor, facilitate performance of operations. The processing system can initiate a purchasing process via a website. The processing system can determine reference amounts of reference data traffic associated with different web pages of the purchasing process. The processing system can monitor encrypted traffic associated with the website resulting in monitored data traffic segments. The processing system can compare monitored amounts of the monitored data traffic segments with the reference amounts of the reference data traffic. The processing system can determine probabilities based on the comparing. The processing system can determine a probability that a purchase was made according to the probabilities.

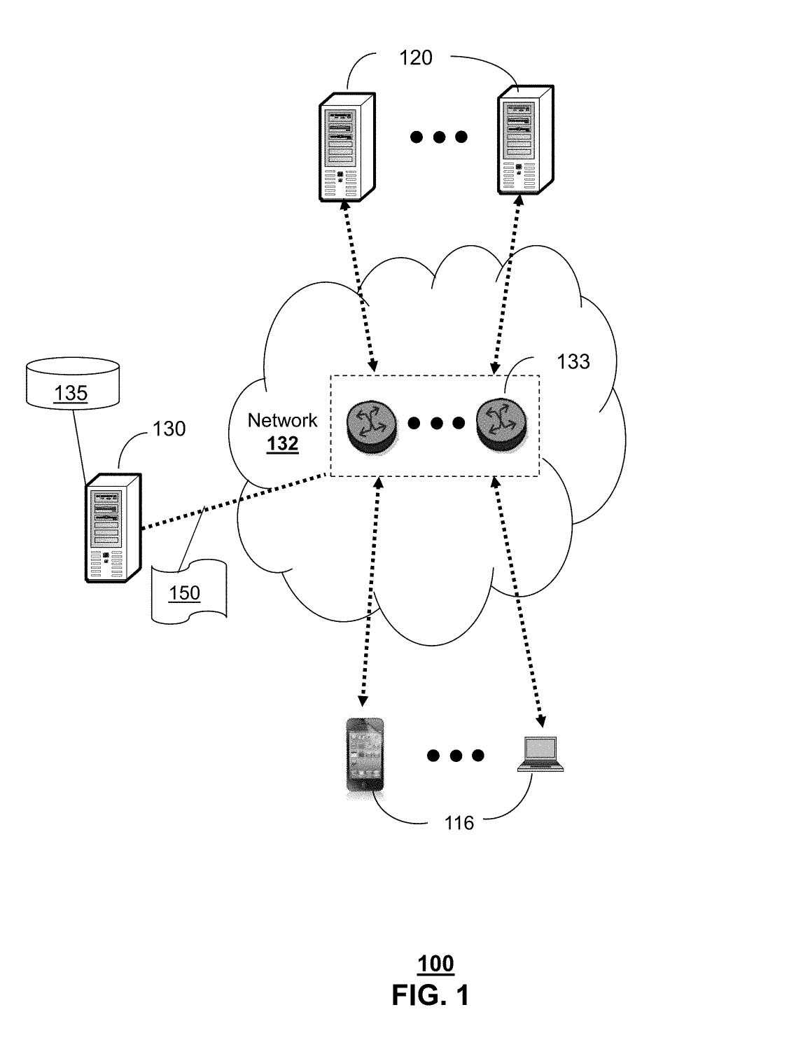

FIG. 1 depicts an illustrative embodiment of a system 100 that allows determining a probability or otherwise estimating whether purchases have been made at websites. System 100 can analyze encrypted traffic without decrypting that traffic and can determine a probability that the encrypted traffic represents a purchase having been made at a website. System 100 can perform this monitoring, analysis and determination for various websites operated by website servers 120 in order to generate purchasing probability information including determining purchasing trends associated with individual entity merchants, groups of entity merchants in a particular industry (e.g., home improvement stores), and/or website-based purchasing for a particular time period. The websites can be associated with different entities, such as different merchants, at different locations.

System 100 illustrates a group of computing devices 116 such as end user devices (e.g., mobile phones, desktop computers, set top boxes, gaming consoles, personal digital assistants) that enable access to the websites operated by the website servers 120. The computing devices 116 can be other types of communication devices that enable purchasing from a website with or without human intervention, including IoT devices (e.g., a smart appliance that accesses a website to purchase a supply associated with the appliance). The computing devices 116 can be associated with different users at different locations, including fixed locations (e.g., a desktop computer at a premises) and in transit (e.g., a vehicle communication system with wireless access).

In one embodiment, the computing devices 116 can access (e.g., over the Internet) the websites via a network 132, which can utilize various components (e.g., network elements 133), technologies, protocols and so forth to provide communication services between the computing devices 116 and the website servers 120. The network 132 can be a wired network, a wireless network or a combination thereof, and can operate according to various communication protocols and radio access technologies, including 3G, 4G and/or 5G. The network 132 can provide communication services (e.g., voice video, data and/or messaging) to various end user devices including mobile and/or fixed communication devices.

System 100 includes one or more servers 130 (only one of which is shown) that can determine a probability that a purchase was made at a particular website according to an analysis of encrypted data without decrypting the data. The analysis can be based on determining reference traffic patterns associated with a purchase at the website and comparison of encrypted traffic with the reference traffic patterns to determine a probability that the particular portion of encrypted traffic represents a completed purchase.

In one or more embodiments, server 130 can perform a training or machine learning process by automatically purchasing an item (e.g., a low cost item) from a website and monitoring the resulting traffic patterns associated with that purchase. The traffic patterns can include uploads and/or downloads, such as for a shopping cart page, check-out page, payment details page, uploading payment information and/or confirmation page. For example, after initiating the purchase at a first website, the server 130 can determine reference amounts of reference data traffic associated with different web pages of the purchasing process for that website. This training or learning session can be repeated for the same website to confirm the reference traffic patterns and/or to monitor for changes to the reference traffic patterns. The training or learning session can also be performed and repeated for other websites to establish reference traffic patterns for each of the other websites and/or to monitor for changes to the reference traffic patterns for each of the other websites. The reference traffic patterns for each of the websites can be stored in a database 135.

In one or more embodiments, system 100 allows analysis of encrypted web sites (or a portion of the traffic thereof) where the server may not be able to “see” (i.e., unencrypted) anything other than the primary domain. For example, server 130 can make small purchases (e.g., from time to time) on a web-retailer's web site. When doing so, the server 130 can observe several key characteristics of an on-line check-out purchase. As an example, when one goes to a shopping cart of a website, the size of the data transaction sent from the retailer to the computing device typically does not have advertisements. The size of the data transaction can vary based on what is in the shopping cart, but typically will be within a size range determined by the text required to describe what is being purchased. For instance, the size range can be within a few hundred bytes. The next thing that typically happens is that the purchaser chooses to “check out now” which results in a standard sized data transaction back to the retailer. Next, the retailer website typically sends a page asking for method of payment which can also be a replicated data volume. This page typically does not have embedded advertisements. The purchaser can typically choose to check out as a guest or returning customer, both of which result in one of two replicated data volumes back to the retailer website. After check-out completion, the retailer website typically sends a final confirmation of a successful check-out which also typically has no advertisements in it and is of a predictable data volume.

These observations can be recorded by the server 130 per web domain to establish reference traffic patterns indicative of a purchasing procedure of a particular website (i.e., training) and can be updated as frequently as the web crawler of server 130 makes small purchases to re-learn, or otherwise monitor for adjustments of, the details. In one embodiment, the training can be performed on a scheduled basis, such as one or more times a day, and/or can be performed responsive to a triggering event, such as detecting an anomaly, such as a statistically significant change in monitored encrypted data or a statistically significant change in results (e.g., a large decrease in estimated completed purchase transactions).

Once reference traffic patterns are established, such as reference amounts for reference data traffic representing downloaded particular web pages and/or uploaded information associated with a purchasing process of a particular website, the server 130 can monitor traffic associated with that website for determining the probability that a purchase has been made by an end user device accessing the website. The monitored traffic can include encrypted and/or unencrypted traffic associated with the website.

In one embodiment, a search performed by an end user device (e.g., a search of items available via the website) can initiate or otherwise trigger monitoring and/or analyzing traffic associated with the website and the end user device. In one embodiment, the server 130 can determine a subject matter of a search performed at the end user device accessing the website. The search can be within the website and/or can be a search outside of the website (e.g., using an Internet search engine). The server 130 can determine a search-based probability based on the subject matter of the search and can then determine a probability that the purchase was made based on the search-based probability, such as in conjunction with other determined probabilities based on traffic patterns as described herein. In this example, information such as known prior purchases, demographics, user preferences or other information can be utilized in determining a likelihood that a user has initiated a purchasing process at a website. In another embodiment, a transition from unencrypted traffic to encrypted traffic (which can be indicative of initiating a purchasing process) can initiate or otherwise trigger monitoring and/or analyzing traffic associated with the website and the end user device.

In one embodiment, server 130 can analyze monitored data traffic segments 150 of the encrypted traffic by comparing monitored amounts of the monitored data traffic segments with the reference amounts of the reference data traffic to determine differential traffic amounts. In this example, the server 130 can determine probabilities based on the differential traffic amounts and can determine a probability that a purchase was made according to the probabilities. The monitored data traffic segments 150 can be indicative of downloads of particular web pages and uploads of particular information. In one embodiment, transitions from downloads to uploads at an end user device accessing the website can be detected and correlated with downloading of different webpages, such as for distinguishing between different data traffic segments that are being analyzed as possible encrypted web page downloads.

System 100 allows encrypted internet traffic to be compared to the baseline profile for a check-out transaction on a particular domain. In one, some or all of the comparisons of monitored and reference amounts (for the data traffic segments), probabilities of correct matches can be determined and a total probability for purchase transaction being completed can be derived from the probabilities, such as the multiplication of the individual comparison probabilities.

As an example, server 130 can determine that an end user device is accessing retailerABC.com and can further detect a transition to an encrypted web page having a data transaction size of X with no ad-bot traffic. According to a comparison of data transaction size of X with a reference amount (e.g., a single amount or a range) for the shopping cart webpage of retailerABC.com, this can be determined to be a 90% probability determination that the end user device is accessing the shopping cart webpage. The server 130 may then detect an encrypted data traffic upload from the end user device having an exact size (or within a designated range) expected for hitting the “check out now” button, which results in a 100% probability determination. For instance, the server 130 can compare another data transaction size of Y with another reference amount (e.g., a single amount or a range) for the “check out now” button upload of retailerABC.com.

Continuing with the example, the server 130 can detect (based on a comparison of monitored and reference amounts) another encrypted downloaded page having an exact data volume (or within a designated range) known for the “enter your payment information” page, which results in a 100% probability determination. The server 130 may then detect an encrypted data traffic upload from the end user device having a size in proximity to the reference amount expected for uploading payment information, which results in a 90% probability determination. In one embodiment, since payment information can vary, the probability can be based on proximity to a reference amount, which can be a single amount (e.g., an average determined from multiple training sessions performed by server 130 for the particular domain) or can be a range.

The server 130 can detect (based on a comparison of monitored and reference amounts) another encrypted downloaded page with no ad-bot traffic and having an exact data volume (or within a designated range) known for the final confirmation page, which results in a 100% probability determination. For this example, the total probability that a purchase transaction was completed can be determined as 0.9*1.0*1.0*0.9*1.0=0.81 or an 81% probability that this was a completed check-out event. As described herein, the reference amounts can be single amounts and/or can be ranges and individual probability determinations can be a probability that the monitored data traffic segment is one of the sequences of the purchasing process.

In one embodiment, system 100 can credit an aggregate of check-out events for the timeline of interest with 0.81 equivalent check-outs. In some instances, the conclusion that a purchase transaction occurred may be incorrect, but this statistical methodology can nominally improve the counting of check-out events over hundreds or thousands or more of such events. Thus, a predictable sequence of data transactions of predictable size (or size range) having predictable IP fetches for advertisements (or lack thereof) can culminate in a predictable ending which is typically a cessation of activity on that domain. System 100 can utilize statistical methods to weight the probability that any transaction sequence is in fact a check-out sequence.

In one or more embodiments, other information can be utilized in determining whether a purchase transaction has occurred. For example, system 100 can monitor for the domain being used immediately prior to these predicable events and characteristics. In another example, it can be determined that specific users have a tendency to make purchases repetitively at certain on-line retailers, which can be utilized as part of determining whether a purchase transaction has occurred.

In one embodiment, system 100 can predict or otherwise make an assertion about what is being purchased according to search details prior to the check-out process (e.g., within a particular time period before the check-out process). In one embodiment, this information can be utilized for weighting the potential sales volume pertaining to the check-out event.

Although most or all of the data traffic being analyzed may be encrypted, statistical confidence intervals are tight given the sample sizes that can be obtained by a service provider. For example, even with sample sets of 300-400 samples, confidence intervals better than 95% are achieved. With tens of thousands of events, our sales volume predictions would likely have confidence intervals on the order of tenths of a percent.

In one embodiment, the server(s) 130 can be a dedicated device that performs both training and monitoring/analysis as described herein. In another embodiment, different servers 130 can be dedicated to different aspects of the process described herein. For example, some servers 130 can perform training to determine reference amounts of reference data traffic associated with different web pages of a purchasing process of particular websites while other servers 130 monitor encrypted traffic, compare monitored amounts with reference amounts of reference data traffic, determine probabilities based on the comparing, and determine a probability that a purchase was made according to the probabilities as described herein.

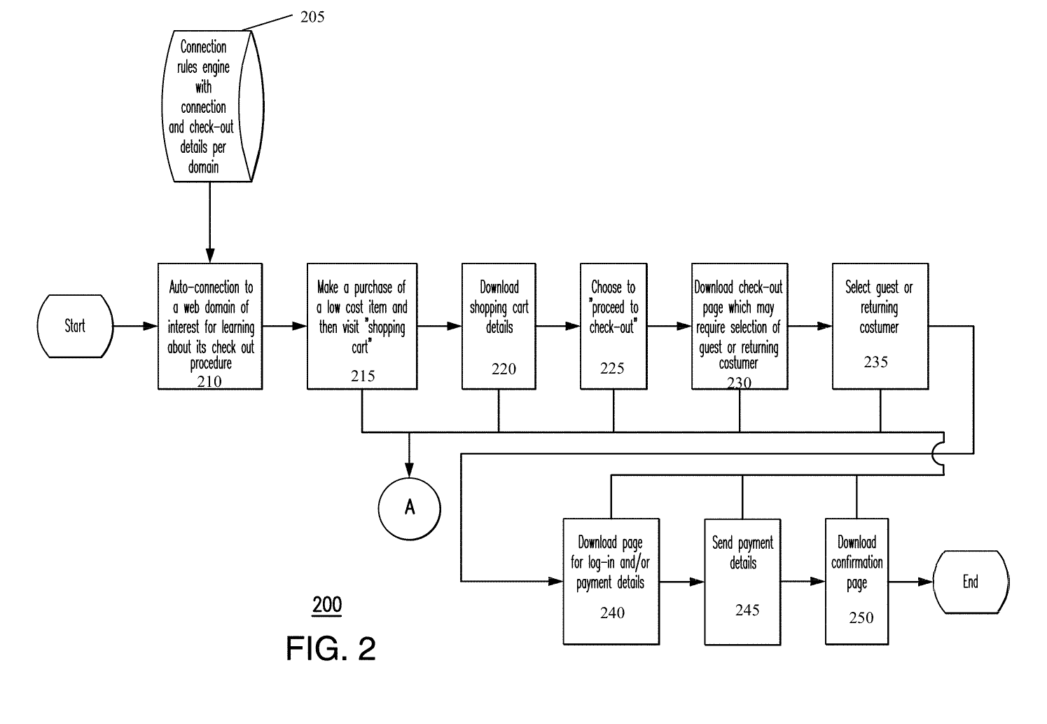

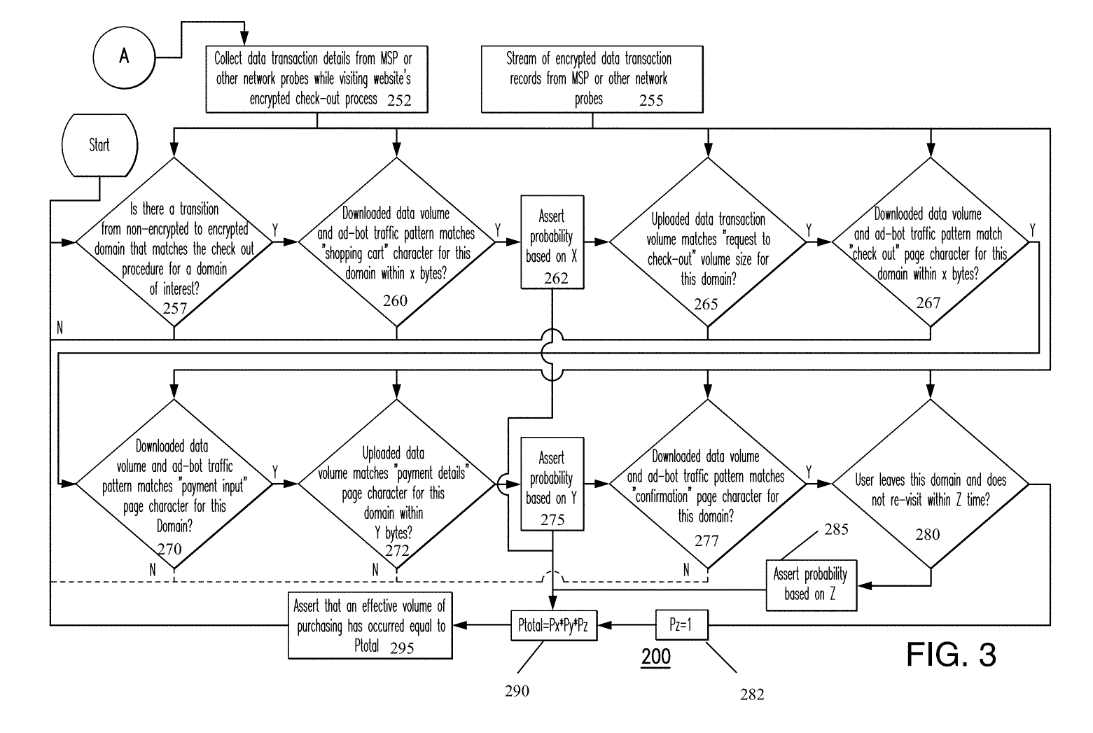

FIGS. 2-3 depict an illustrative embodiment of a method used by system 100 for determining reference amounts for reference data traffic and for determining a probability that a purchase transaction has occurred. Method 200 includes a training portion (205-252) and a monitoring/probability determination portion (255-295). At 205, the server 130 can access a connection rules engine with connection and check-out details per domain. As an example, the server 130 can be performing training on a website for a first time whereby the connection rules engine can provide relevant information for, or otherwise facilitate establishing, a connection with the website. In another example, the server 130 can be repeating training on a website so the connection rules engine can provide the server 130 with previously determined reference traffic patterns (e.g., reference amounts of reference data traffic per webpage or other data transaction).

Accessing the previously determined baseline profile for the website can allow the server 130 to detect changes or anomalies associated with accessing the website. For example during a subsequent training session, the server 130 can detect a large increase in a reference amount of reference data traffic associated with a shopping cart page as compared to previously performed training sessions. The server 130 can analyze the shopping cart page to detect changes from previous training sessions (e.g., previously recorded webpages and/or reference amounts of reference data traffic associated with that webpage), such as the addition of ad-bot traffic. In one embodiment, the server 130 can determine or estimate whether a website server 120 is implementing padding of encrypted traffic to disguise traffic volumes, such as by detecting uniform volumes for each of the different webpages and/or detecting uniform volumes during different training sessions for the same webpage where variations of the data amount for the webpage(s) are expected (e.g., shopping cart webpages may have variations due to the items being purchased). In one embodiment, the accuracy of further monitoring of a particular website can be analyzed, such as whether method 200 will accurately determine reference amounts if the webpages are being data traffic padded.

At 210, the server 130 can access the website. The server 130 can perform the connection and various other steps of method 200 without user intervention as a web crawler collecting data based on purchasing procedures at each of the visited websites. At 215, the server 130 can initiate a purchase process and can visit the shopping cart webpage (or its equivalent). The particular product being purchased can be based on a number of factors including price, brand, and so forth.

The server 130 can perform each of the steps needed to complete the purchase transaction, including uploading relevant information to the website. As an example at 220, the server 130 can download the shopping cart details and at 225 the server can proceed to check-out. At 230, the server 130 can download a check-out page which may require selection as a returning customer or guest. At 235, the server 130 can select one of the returning customer or guest, and the purchasing process can later be repeated by the server 130 including selecting the other of the returning customer or guest so that the baseline profile for the website includes relevant traffic patterns (e.g., data volumes) for both options. At 240, the server 130 can download the payment information page, such as a log-in for returning customers or a payment details input page. At 245, the server 130 can upload the requisite information, such as the payment details, user name and/or password. At 250, the server 130 can download the purchase confirmation page.

Each traffic pattern (e.g., reference amount of data, existence of ad-bot traffic, timing information, and so forth) for the uploads and/or downloads associated with 215-250 can be determined at 252. For example, the server 130 can collect data transaction details such as from a Managed Service Provider (MSP) equipment and/or other network probes. These data transaction details can form a baseline profile for the particular domain, including reference amounts of reference data traffic associated with different web pages of the purchasing process, which can be stored in database 135. FIG. 2 illustrates an end to the training session, however as described herein, the training session can be repeated, such as according to a schedule and/or based on a triggering event (e.g., a detected anomaly in monitored data traffic).

At 255, the monitoring/probability determination of method 200 can include the server 130 monitoring or otherwise being provided with access to a stream of encrypted data transaction records from the MSP equipment and/or other network probes. Other techniques can be used for analyzing the monitored data traffic, including using multiple servers that are dedicated to a type of monitoring, such as for monitoring encrypted traffic for a particular website or group of websites, monitoring upload traffic from end user devices, monitoring download traffic to the end user devices, and so forth.

FIG. 3 depicts a start to the monitoring/probability determination to illustrate that the training and the monitoring/probability determination can be separate processes performed by separate servers or can be a combined process, such as performed by a server. The timing of performing either the training session or the monitoring/probability determination can vary. In one embodiment, the server 130 can perform the monitoring/probability determination in real-time or near real-time with respect to the monitored data traffic.

At 257, the server 130 can determine whether the data traffic for an end user device accessing a particular domain indicates a transition from non-encrypted to an encrypted domain that matches or otherwise correlates with a check-out procedure for the domain of interest. If the transition is not detected then method 200 can continue monitoring for the transition, otherwise if the transition is determined to have occurred then at 260 a comparison of a monitored traffic pattern with a reference traffic pattern can be performed to detect a correlation. For instance, the server 130 can determine whether a downloaded data volume and ad-bot traffic pattern matches or correlates with the reference data volume and reference ad-bot traffic pattern of a downloaded shopping cart webpage for the particular domain, such as a monitored data volume within X bytes. The monitored data traffic can be a segment of traffic associated with the website and the end user device. In one embodiment, the segment (as well as other segments described herein) can be determined according to transitions in data traffic between uploads and downloads for the end user device.

If at 260 there is no data volume match within X bytes then method 200 can return to monitoring for the transition, otherwise if there is a match within X bytes then at 262 a probability can be determined based on a data volume differential. For example, an exact match of data volume between the monitored traffic segment and the reference data traffic can result in a 100% probability determination (for that sequence of the purchasing process) whereas a data volume differential between the monitored traffic segment and the reference data traffic which is close to the X bytes threshold can result in a lower probability. In this example, as the differential between the monitored data volume and the reference data volume increases, the probability determination becomes lower.

At 265, another comparison of a monitored traffic pattern with a reference traffic pattern can be performed to detect a correlation which would correspond to a sequence in the purchase process. The server 130 can determine whether an uploaded data volume matches or correlates with the reference data volume of a request to check-out for the particular domain. The monitored data traffic can be another segment of traffic associated with the website and the end user device.

If at 265 there is no data volume match (such as an exact match and/or within a particular range) then method 200 can return to monitoring for the transition, otherwise if there is a match then at 267 another comparison of a monitored traffic pattern with a reference traffic pattern can be performed to detect another correlation which would correspond to another sequence in the purchase process. The server 130 can determine whether a downloaded data volume and ad-bot traffic pattern matches or correlates with the reference data volume and reference ad-bot traffic pattern of a downloaded check-out webpage for the particular domain. The monitored data traffic can be another segment of traffic associated with the website and the end user device. In one embodiment, this comparison can be based on a threshold number of bytes, such as X bytes described with respect to 260-262, and another probability can be determined based on a data volume differential between the monitored traffic segment and the reference data traffic, such as a 100% probability determination for an exact match and a lower probability determination as the data volume differential increases. In another embodiment, the comparison at 267 can be utilized for determining whether method 200 is to continue the evaluation or whether the method is to return to monitoring for the transition at 257.

If at 267 there is no data volume match (such as an exact match and/or within a particular range) then method 200 can return to monitoring for the transition, otherwise at 270 another comparison of a monitored traffic pattern with a reference traffic pattern can be performed to detect another correlation which would correspond to another sequence in the purchase process. The server 130 can determine whether a downloaded data volume and ad-bot traffic pattern matches or correlates with the reference data volume and reference ad-bot traffic pattern of a downloaded payment input webpage for the particular domain. The monitored data traffic can be another segment of traffic associated with the website and the end user device.

If at 270 there is no data volume match (such as an exact match and/or within a particular range) then method 200 can return to monitoring for the transition, otherwise if there is a match then at 272 a comparison of a monitored traffic pattern with a reference traffic pattern can be performed to detect another correlation which would correspond to another sequence in the purchase process. The server 130 can determine whether an uploaded data volume matches or correlates with the reference data volume of an uploaded payment details for the particular domain, such as data volume within Y bytes. The monitored data traffic can be another segment of traffic associated with the website and the end user device.

If at 272 there is no data volume match within Y bytes then method 200 can return to monitoring for the transition, otherwise if there is a match within Y bytes then at 275 a probability can be determined based on a data volume differential. For example, an exact match of data volume between the monitored traffic segment and the reference data traffic can result in a 100% probability determination (for that sequence of the purchasing process) whereas a data volume differential between the monitored traffic segment and the reference data traffic which is close to the Y bytes threshold can result in a lower probability. In this example, as the differential between the monitored data volume and the reference data volume increases, the probability determination becomes lower.

At 277, another comparison of a monitored traffic pattern with a reference traffic pattern can be performed to detect another correlation which would correspond to another sequence in the purchase process. The server 130 can determine whether a downloaded data volume and ad-bot traffic pattern matches or correlates with the reference data volume and reference ad-bot traffic pattern of a downloaded confirmation webpage for the particular domain. The monitored data traffic can be another segment of traffic associated with the website and the end user device.

If at 277 there is no data volume match (such as an exact match and/or within a particular range) then method 200 can return to monitoring for the transition, otherwise if there is a match then at 280 the server 130 can determine whether the monitored data traffic indicates that the end user device subsequently left the domain and/or whether the end user device did not revisit the domain within Z time period. In one embodiment, the server 130 can determine a time-based probability according to the Z time period. For example at 282, a probability of 100% can be determined (for that sequence of the purchasing process) based on the Z time period expiring prior to detecting that the end user device has subsequently accessed the website. In another example at 285, a lower probability can be determined when the end user device is detected revisiting the webpage within the Z time period. In this example, a higher probability results from a longer time period that the end user device does not revisit the website. In one embodiment, the use of a time-based probability is based on a user typically leaving a website after making a purchase, as opposed to continue browsing the website.

At 290, the server 130 can determine a probability that a purchase was made according to the individual probabilities of the sequences of the purchasing process, such as based on multiplying the probabilities. Other probability models and algorithms can also be applied, including algorithms that are determined according to an analysis of multiple training sessions for each of the websites. At 295, the completed purchase probability can be aggregated with other completed purchase probabilities determined for other end user devices that have accessed the website. Method 200 allows estimating sales volumes for on-line retailers even when check-out events are fully encrypted. This information can be utilized to determine whether on-line sales are going up, down, or remaining steady.

While for purposes of simplicity of explanation, the respective processes are shown and described as a series of blocks in FIG. 2, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. As an example, a sequence probability can be applied to one, some or all of the traffic segment comparisons according to a data volume differential between monitored data traffic and reference data traffic. These resulting sequence probabilities can then be used to determine the completed purchase probability for the particular communication session of the end user device.

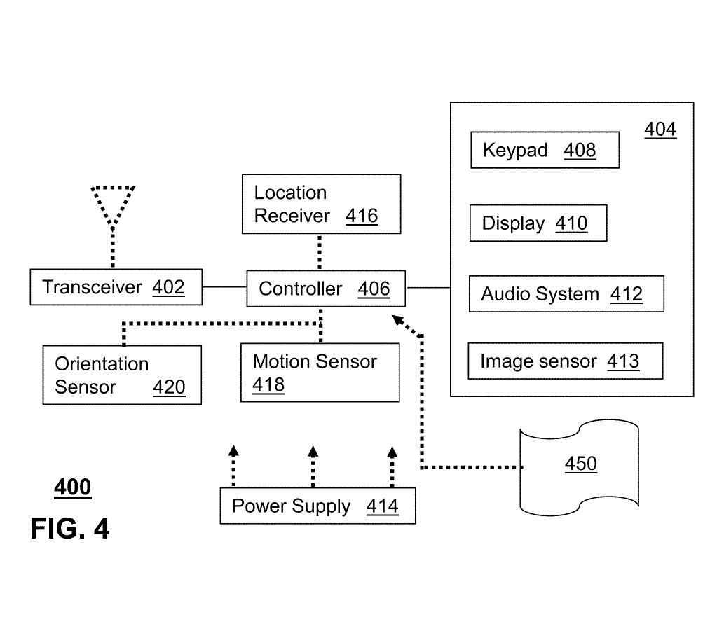

FIG. 4 depicts an illustrative embodiment of a communication device 400. Communication device 400 can serve in whole or in part as an illustrative embodiment of the devices depicted in FIG. 1 and can be configured to perform portions of method 200 of FIGS. 2-3. As an example, communication device 400 can access a website and can initiate a purchasing process via the website. The communication device 400 can determine a first reference amount of first reference data traffic associated with a first web page representing a shopping cart of the purchasing process. The communication device 400 can determine a second reference amount of second reference data traffic associated with payment information for the purchasing process. The communication device 400 can complete the purchasing process and can monitor encrypted traffic associated with the website. The communication device 400 can compare a first monitored amount of first monitored data traffic of the encrypted traffic with the first reference amount of the first reference data traffic to determine a first differential traffic amount. The communication device 400 can determine a first probability based on the first differential traffic amount. The communication device 400 can compare a second monitored amount of second monitored data traffic of the encrypted traffic with the second reference amount of the second reference data traffic to determine a second differential traffic amount. The communication device 400 can determine a second probability based on the second differential traffic amount. The communication device 400 can determine a probability that a purchase was made according to the first and second probabilities.

In one embodiment, the communication device 400 can detect that an end user device associated with the encrypted traffic is no longer accessing the website; compare a time period after the detecting that the end user device is not accessing the website with a threshold time period to determine a time period differential; determine a third probability based on the time period differential; and determine the probability that the purchase was made based in part on the third probability. In one embodiment, the communication device 400 can determine a third reference amount of third reference data traffic associated with a second web page representing a check out of the purchasing process; and determine whether a third monitored amount of third data traffic of the encrypted traffic is within a threshold amount of the third reference amount of the third reference data traffic.

In one embodiment, the communication device 400 can determine a fourth reference amount of fourth reference data traffic associated with a third web page representing a confirmation of the purchasing process; and determine whether a fourth monitored amount of fourth data traffic of the encrypted traffic is within another threshold amount of the fourth reference amount of the fourth reference data traffic. In one embodiment, the communication device 400 can determine an anomaly associated with the first monitored amount of the first monitored data traffic, the second monitored amount of the second monitored data traffic, the third monitored amount of the third monitored data traffic, the fourth monitored amount of the fourth monitored data traffic, or a combination thereof; and responsive to the determining the anomaly, repeat at least one of the determining of the first reference amount of the first reference data traffic, the determining of the second reference amount of the second reference data traffic, the determining of the third reference amount of the third reference data traffic, and the determining of the fourth reference amount of the fourth reference data traffic during another purchasing process via the website.

In one embodiment, the communication device 400 can detect a transition from unencrypted traffic associated with the website to the encrypted traffic associated with the website, where the comparing the first monitored amount of the first monitored data traffic with the first reference amount of the first reference data traffic is initiated based on the detecting the transition. In one embodiment, the determining the second reference amount of the second reference data traffic associated with the payment information can include determining different reference amounts for a guest and for a returning customer. In one embodiment, the second monitored data traffic of the encrypted traffic can be an upload from an end user device accessing the website. In one embodiment, the communication device 400 can determine a subject matter of a search performed at an end user device accessing the website; determine a third probability based on the subject matter of the search; and determine the probability that the purchase was made based in part on the third probability.

Communication device 400 can comprise a wireline and/or wireless transceiver 402 (herein transceiver 402), a user interface (UI) 404, a power supply 414, a location receiver 416, a motion sensor 418, an orientation sensor 420, and a controller 406 for managing operations thereof. The transceiver 402 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 402 can also be adapted to support circuit-switched wireline access technologies (such as PSTN), packet-switched wireline access technologies (such as TCP/IP, VoIP, etc.), and combinations thereof.

The UI 404 can include a depressible or touch-sensitive keypad 408 with a navigation mechanism such as a roller ball, a joystick, a mouse, or a navigation disk for manipulating operations of the communication device 400. The keypad 408 can be an integral part of a housing assembly of the communication device 400 or an independent device operably coupled thereto by a tethered wireline interface (such as a USB cable) or a wireless interface supporting for example Bluetooth®. The keypad 408 can represent a numeric keypad commonly used by phones, and/or a QWERTY keypad with alphanumeric keys. The UI 404 can further include a display 410 such as monochrome or color LCD (Liquid Crystal Display), OLED (Organic Light Emitting Diode) or other suitable display technology for conveying images to an end user of the communication device 400. In an embodiment where the display 410 is touch-sensitive, a portion or all of the keypad 408 can be presented by way of the display 410 with navigation features.

The display 410 can use touch screen technology to also serve as a user interface for detecting user input. As a touch screen display, the communication device 400 can be adapted to present a user interface with graphical user interface (GUI) elements that can be selected by a user with a touch of a finger. The touch screen display 410 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 410 can be an integral part of the housing assembly of the communication device 400 or an independent device communicatively coupled thereto by a tethered wireline interface (such as a cable) or a wireless interface.

The UI 404 can also include an audio system 412 that utilizes audio technology for conveying low volume audio (such as audio heard in proximity of a human ear) and high volume audio (such as speakerphone for hands free operation). The audio system 412 can further include a microphone for receiving audible signals of an end user. The audio system 412 can also be used for voice recognition applications. The UI 404 can further include an image sensor 413 such as a charged coupled device (CCD) camera for capturing still or moving images.

The power supply 414 can utilize common power management technologies such as replaceable and rechargeable batteries, supply regulation technologies, and/or charging system technologies for supplying energy to the components of the communication device 400 to facilitate long-range or short-range portable applications. Alternatively, or in combination, the charging system can utilize external power sources such as DC power supplied over a physical interface such as a USB port or other suitable tethering technologies.

The location receiver 416 can utilize location technology such as a global positioning system (GPS) receiver capable of assisted GPS for identifying a location of the communication device 400 based on signals generated by a constellation of GPS satellites, which can be used for facilitating location services such as navigation. The motion sensor 418 can utilize motion sensing technology such as an accelerometer, a gyroscope, or other suitable motion sensing technology to detect motion of the communication device 400 in three-dimensional space. The orientation sensor 420 can utilize orientation sensing technology such as a magnetometer to detect the orientation of the communication device 400 (north, south, west, and east, as well as combined orientations in degrees, minutes, or other suitable orientation metrics).

The communication device 400 can use the transceiver 402 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 406 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 400.

Other components not shown in FIG. 4 can be used in one or more embodiments of the subject disclosure. For instance, the communication device 400 can include a reset button (not shown). The reset button can be used to reset the controller 406 of the communication device 400. In yet another embodiment, the communication device 400 can also include a factory default setting button positioned, for example, below a small hole in a housing assembly of the communication device 400 to force the communication device 400 to re-establish factory settings. In this embodiment, a user can use a protruding object such as a pen or paper clip tip to reach into the hole and depress the default setting button. The communication device 400 can also include a slot for adding or removing an identity module such as a Subscriber Identity Module (SIM) card. SIM cards can be used for identifying subscriber services, executing programs, storing subscriber data, and so forth.

The communication device 400 as described herein can operate with more or less of the circuit components shown in FIG. 4. These variant embodiments can be used in one or more embodiments of the subject disclosure. The communication device 400 can be adapted to perform the functions of server 130 or other devices of system 100. It will be appreciated that the communication device 400 can also represent other devices that can operate in system 100. In addition, the controller 406 can be adapted in various embodiments to perform the functions 450 which can include: initiating a purchasing process via a website; determining reference amounts of reference data traffic associated with different web pages of the purchasing process; monitoring encrypted traffic associated with the website resulting in monitored data traffic segments; comparing monitored amounts of the monitored data traffic segments with the reference amounts of the reference data traffic to determine differential traffic amounts; determining probabilities based on the differential traffic amounts; determining a probability that a purchase was made according to the probabilities; detecting a transition from unencrypted traffic associated with the website to the encrypted traffic associated with the website, wherein the comparing the monitored amounts of the monitored data traffic with the reference amounts of the reference data traffic is initiated based on the detecting the transition; determining a time-based probability according to timing data associated with detecting that an end user device associated with the encrypted traffic is no longer accessing the website; determining the probability that the purchase was made based in part on the time-based probability; determining other reference amounts of other reference data traffic associated with other different web pages of the purchasing process; determining whether other monitored amounts of the monitored data traffic segments are within a threshold amount of the other reference amounts of the other reference data traffic; determining an anomaly associated with at least one of the monitored amounts of the monitored data traffic segments; and responsive to the determining the anomaly, repeating the determining the reference amounts of the reference data traffic during another purchasing process via the website. In one embodiment, the monitored data traffic segments of the encrypted traffic include upload traffic and download traffic of an end user device accessing the website. In one embodiment, the different web pages represent a shopping cart of the purchasing process and payment details of the purchasing process. In one embodiment, the other different web pages represent a check out of the purchasing process and a confirmation of the purchasing process.

In one embodiment, the functions 450 can include: initiating a purchasing process via a website; determining reference amounts of reference data traffic associated with different web pages of the purchasing process; monitoring encrypted traffic associated with the website resulting in monitored data traffic segments; comparing monitored amounts of the monitored data traffic segments with the reference amounts of the reference data traffic; determining probabilities based on the comparing; determining a probability that a purchase was made according to the probabilities; detecting a transition from unencrypted traffic associated with the website to the encrypted traffic associated with the website, wherein the comparing the monitored amounts of the monitored data traffic with the reference amounts of the reference data traffic is initiated based on the detecting the transition; determining an anomaly associated with at least one of the monitored amounts of the monitored data traffic segments; and responsive to the determining the anomaly, repeating the determining the reference amounts of the reference data traffic during another purchasing process via the website.

Upon reviewing the aforementioned embodiments, it would be evident to an artisan with ordinary skill in the art that said embodiments can be modified, reduced, or enhanced without departing from the scope of the claims described below. For example, the traffic patterns can be based solely on data volumes or can be additionally based on other traffic pattern indicia such as time-based factors, common encrypted data, and so forth. In one embodiment, the analysis can be utilized to track incomplete website sales, which may be indicative of whether the website is user-friendly. System 100 and method 200 allow a more accurate estimation of completed purchase transaction at websites as compared to other monitoring techniques, such as search histories, accessing the website, and so forth which can indicate an end user's interest but do not accurately estimate whether a purchase was completed.

In one embodiment, system 100 and method 200 can predict that a purchase transaction was completed at a website without decrypting user traffic and without determining what was purchased. In another embodiment, system 100 and method 200 can predict that a purchase transaction was completed at a website without decrypting user traffic and can also predict a product that was purchased, such as based on search history, user preferences, user demographics, and so forth. In one embodiment, training sessions can be performed for different categories of products at a website to determine if there is a distinction between reference data volumes for the different webpages of the purchasing process. If a distinction is determined then baseline profiles for a website can include difference reference data volumes. For example, search result information prior to initiation of the purchasing process can be indicative of a category of product being purchased and can enable the server 130 select which one of a group of reference data volumes for each web page should be utilized in the comparisons.

In one embodiment, historical information can be accessed to determine a category or type of product to purchase based on a historical indication that the particular category or type of product resulted in a more accurate or more representative reference data amount for particular web pages of the purchasing process. In one embodiment, the historical information can be from different websites, such as determining that product A purchased at website X during several training sessions provided a smaller variance in reference data amounts for webpages of the purchasing processes for the training sessions at website X, and as a result selecting product B which is in a same category as product A when performing training session(s) for website Y. Other embodiments can be used in the subject disclosure.

It should be understood that devices described in the exemplary embodiments can be in communication with each other via various wireless and/or wired methodologies. The methodologies can be links that are described as coupled, connected and so forth, which can include unidirectional and/or bidirectional communication over wireless paths and/or wired paths that utilize one or more of various protocols or methodologies, where the coupling and/or connection can be direct (e.g., no intervening processing device) and/or indirect (e.g., an intermediary processing device such as a router).

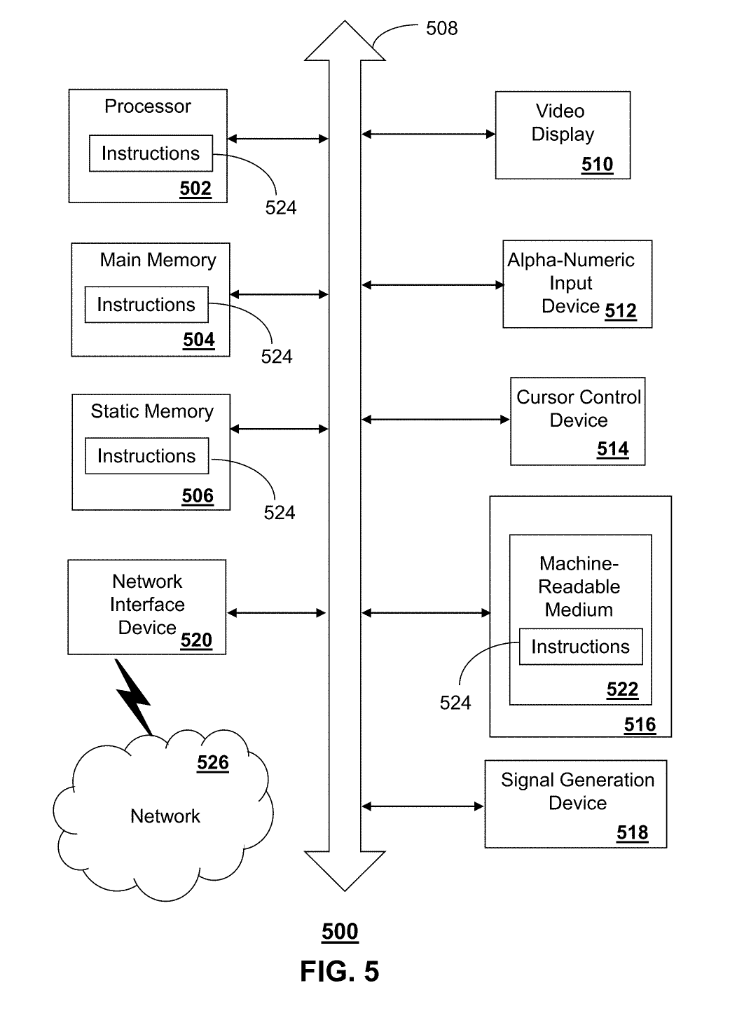

FIG. 5 depicts an exemplary diagrammatic representation of a machine in the form of a computer system 500 within which a set of instructions, when executed, may cause the machine to perform any one or more of the methods described above. One or more instances of the machine can operate, for example, as the server 130 to determine a probability or otherwise estimate whether purchases have been made at particular websites based on an analysis of encrypted traffic. The machine can provide for delivery of raw data session records to a processing sub-system where one or more of domain names, timestamps, transacted data volumes, presence or absence of ad-bot traffic and other information can be used in concert with a specialized web crawler to effect a machine learning system that can identify or otherwise determine a probability as to when a user is making a purchase on a web site.

In some embodiments, the machine may be connected (e.g., using a network 526) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 500 may include a processor (or controller) 502 (e.g., a central processing unit (CPU)), a graphics processing unit (GPU, or both), a main memory 504 and a static memory 506, which communicate with each other via a bus 508. The computer system 500 may further include a display unit 510 (e.g., a liquid crystal display (LCD), a flat panel, or a solid state display). The computer system 500 may include an input device 512 (e.g., a keyboard), a cursor control device 514 (e.g., a mouse), a disk drive unit 516, a signal generation device 518 (e.g., a speaker or remote control) and a network interface device 520. In distributed environments, the embodiments described in the subject disclosure can be adapted to utilize multiple display units 510 controlled by two or more computer systems 500. In this configuration, presentations described by the subject disclosure may in part be shown in a first of the display units 510, while the remaining portion is presented in a second of the display units 510.

The disk drive unit 516 may include a tangible computer-readable storage medium 522 on which is stored one or more sets of instructions (e.g., software 524) embodying any one or more of the methods or functions described herein, including those methods illustrated above. The instructions 524 may also reside, completely or at least partially, within the main memory 504, the static memory 506, and/or within the processor 502 during execution thereof by the computer system 500. The main memory 504 and the processor 502 also may constitute tangible computer-readable storage media.

Dedicated hardware implementations including, but not limited to, application specific integrated circuits, programmable logic arrays and other hardware devices can likewise be constructed to implement the methods described herein. Application specific integrated circuits and programmable logic array can use downloadable instructions for executing state machines and/or circuit configurations to implement embodiments of the subject disclosure. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the operations or methods described herein are intended for operation as software programs or instructions running on or executed by a computer processor or other computing device, and which may include other forms of instructions manifested as a state machine implemented with logic components in an application specific integrated circuit or field programmable gate array. Furthermore, software implementations (e.g., software programs, instructions, etc.) including, but not limited to, distributed processing or component/object distributed processing, parallel processing, or virtual machine processing can also be constructed to implement the methods described herein. Distributed processing environments can include multiple processors in a single machine, single processors in multiple machines, and/or multiple processors in multiple machines. It is further noted that a computing device such as a processor, a controller, a state machine or other suitable device for executing instructions to perform operations or methods may perform such operations directly or indirectly by way of one or more intermediate devices directed by the computing device.

While the tangible computer-readable storage medium 522 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure. The term “non-transitory” as in a non-transitory computer-readable storage includes without limitation memories, drives, devices and anything tangible but not a signal per se.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth®, WiFi, Zigbee®), and long-range communications (e.g., WiMAX, GSM, CDMA, LTE) can be used by computer system 500. In one or more embodiments, information regarding use of services can be generated including services being accessed, media consumption history, user preferences, and so forth. This information can be obtained by various methods including user input, detecting types of communications (e.g., video content vs. audio content), analysis of content streams, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. The exemplary embodiments can include combinations of features and/or steps from multiple embodiments. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order or function unless expressly stated so. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

In one or more embodiments, a processor (which can include a controller or circuit) has been described that performs various functions. It should be understood that the processor can be multiple processors, which can include distributed processors or parallel processors in a single machine or multiple machines. The processor can be used in supporting a virtual processing environment. The virtual processing environment may support one or more virtual machines representing computers, servers, or other computing devices. In such virtual machines, components such as microprocessors and storage devices may be virtualized or logically represented. The processor can include a state machine, application specific integrated circuit, and/or programmable gate array including a Field PGA. In one or more embodiments, when a processor executes instructions to perform “operations”, this can include the processor performing the operations directly and/or facilitating, directing, or cooperating with another device or component to perform the operations.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising:
accessing, by a processing system including a processor, a website;
initiating, by the processing system, a purchasing process via the website;
determining, by the processing system, a first reference amount of first reference data traffic associated with a first web page representing a shopping cart of the purchasing process;
determining, by the processing system, a second reference amount of second reference data traffic associated with payment information for the purchasing process;
completing, by the processing system, the purchasing process;
monitoring, by the processing system, encrypted traffic associated with the website;
comparing, by the processing system, a first monitored amount of first monitored data traffic of the encrypted traffic with the first reference amount of the first reference data traffic to determine a first differential traffic amount;
determining, by the processing system, a first probability based on the first differential traffic amount;
comparing, by the processing system, a second monitored amount of second monitored data traffic of the encrypted traffic with the second reference amount of the second reference data traffic to determine a second differential traffic amount;
determining, by the processing system, a second probability based on the second differential traffic amount; and
determining, by the processing system, a probability that a purchase was made according to the first and second probabilities.

2. The method of claim 1, comprising:
detecting, by the processing system, that an end user device associated with the encrypted traffic is no longer accessing the website;
comparing, by the processing system, a time period after the detecting that the end user device is not accessing the website with a threshold time period to determine a time period differential;
determining, by the processing system, a third probability based on the time period differential; and
determining, by the processing system, the probability that the purchase was made based in part on the third probability.

3. The method of claim 2, comprising:
determining, by the processing system, a third reference amount of third reference data traffic associated with a second web page representing a check out of the purchasing process; and
determining, by the processing system, whether a third monitored amount of third data traffic of the encrypted traffic is within a threshold amount of the third reference amount of the third reference data traffic.

4. The method of claim 3, comprising:
determining, by the processing system, a fourth reference amount of fourth reference data traffic associated with a third web page representing a confirmation of the purchasing process; and
determining, by the processing system, whether a fourth monitored amount of fourth data traffic of the encrypted traffic is within another threshold amount of the fourth reference amount of the fourth reference data traffic.

5. The method of claim 4, comprising:
determining, by the processing system, an anomaly associated with the first monitored amount of the first monitored data traffic, the second monitored amount of the second monitored data traffic, the third monitored amount of the third monitored data traffic, the fourth monitored amount of the fourth monitored data traffic, or a combination thereof; and
responsive to the determining the anomaly, repeating, by the processing system, at least one of the determining of the first reference amount of the first reference data traffic, the determining of the second reference amount of the second reference data traffic, the determining of the third reference amount of the third reference data traffic, and the determining of the fourth reference amount of the fourth reference data traffic during another purchasing process via the website.

6. The method of claim 1, comprising:
detecting, by the processing system, a transition from unencrypted traffic associated with the website to the encrypted traffic associated with the website, wherein the comparing the first monitored amount of the first monitored data traffic with the first reference amount of the first reference data traffic is initiated based on the detecting the transition.

7. The method of claim 1, wherein the determining the second reference amount of the second reference data traffic associated with the payment information comprises determining different reference amounts for a guest and for a returning customer.

8. The method of claim 1, wherein the second monitored data traffic of the encrypted traffic is an upload from an end user device accessing the website.

9. The method of claim 1, comprising:
determining, by the processing system, a subject matter of a search performed at an end user device accessing the website;
determining, by the processing system, a third probability based on the subject matter of the search; and
determining, by the processing system, the probability that the purchase was made based in part on the third probability.

10. A device, comprising:
a processing system including a processor; and
a memory that stores executable instructions that, when executed by the processing system, facilitate performance of operations, comprising:
initiating a purchasing process via a website;
determining reference amounts of reference data traffic associated with different web pages of the purchasing process;
monitoring encrypted traffic associated with the website resulting in monitored data traffic segments;
comparing monitored amounts of the monitored data traffic segments with the reference amounts of the reference data traffic to determine differential traffic amounts;
determining probabilities based on the differential traffic amounts; and
determining a probability that a purchase was made according to the probabilities.

11. The device of claim 10, wherein the operations further comprise:
detecting a transition from unencrypted traffic associated with the website to the encrypted traffic associated with the website, wherein the comparing the monitored amounts of the monitored data traffic with the reference amounts of the reference data traffic is initiated based on the detecting the transition.

12. The device of claim 10, wherein the monitored data traffic segments of the encrypted traffic comprise upload traffic and download traffic of an end user device accessing the website.

13. The device of claim 10, wherein the different web pages represent a shopping cart of the purchasing process and payment details of the purchasing process.

14. The device of claim 10, wherein the operations further comprise:
determining a time-based probability according to timing data associated with detecting that an end user device associated with the encrypted traffic is no longer accessing the website; and
determining the probability that the purchase was made based in part on the time-based probability.

15. The device of claim 10, wherein the operations further comprise:
determining other reference amounts of other reference data traffic associated with other different web pages of the purchasing process; and
determining whether other monitored amounts of the monitored data traffic segments are within a threshold amount of the other reference amounts of the other reference data traffic.

16. The device of claim 15, wherein the other different web pages represent a check out of the purchasing process and a confirmation of the purchasing process.

17. The device of claim 10, wherein the operations further comprise:
determining an anomaly associated with at least one of the monitored amounts of the monitored data traffic segments; and
responsive to the determining the anomaly, repeating the determining the reference amounts of the reference data traffic during another purchasing process via the website.

18. A machine-readable storage medium, comprising executable instructions that, when executed by a processing system including a processor, facilitate performance of operations, comprising:
initiating a purchasing process via a website;
determining reference amounts of reference data traffic associated with different web pages of the purchasing process;
monitoring encrypted traffic associated with the website resulting in monitored data traffic segments;
comparing monitored amounts of the monitored data traffic segments with the reference amounts of the reference data traffic;
determining probabilities based on the comparing; and
determining a probability that a purchase was made according to the probabilities.

19. The machine-readable storage medium of claim 18, wherein at least one of the reference amounts comprises a range of amounts, and wherein the operations further comprise:
detecting a transition from unencrypted traffic associated with the website to the encrypted traffic associated with the website, wherein the comparing the monitored amounts of the monitored data traffic with the reference amounts of the reference data traffic is initiated based on the detecting the transition.

20. The machine-readable storage medium of claim 18, wherein the operations further comprise:
determining an anomaly associated with at least one of the monitored amounts of the monitored data traffic segments; and
responsive to the determining the anomaly, repeating the determining the reference amounts of the reference data traffic during another purchasing process via the website.
